(19) United States
(12) Patent Application Publication
(10) Pub. No.: US 2009/0294233 A1
(43) Pub. Date: Dec. 3, 2009

(54) DRIVE DEVICE FOR A HYDRAULIC CALIPER BRAKE ASSEMBLY

(76) Inventor: Wayne-Ian MOORE, Changhua City (TW)

Correspondence Address: Chien-Hui Su, P. O. Box 70-121 Taichung, Taichung City, 40899, TW

(21) Appl. No.: 12/131,940

(22) Filed: Jun. 3, 2008

(51) Int. Cl. B60T 11/10

(52) U.S. Cl. 188/361

(57) ABSTRACT

A drive device for a hydraulic caliper brake assembly includes a housing having an open chamber and an elastomer sealingly mounted in the chamber for containing brake oil. The elastomer includes a skirt connected to an inner peripheral of the chamber, a projection adapted to a brake shoe, and a U-shaped portion positioned between the skirt and the projection for providing the displacement of the projection. A plate is disposed between the housing and the elastomer. A shoulder mounted on the plate is corresponded to an annular flange mounted on elastomer for retaining the elastomer. When hydraulic pressure is greater than the elastic force of the elastomer, the projection of the elastomer is pushed toward the brake shoe to achieve the braking purpose. On the contrary, the projection of the elastomer is restored to a free condition.

### BACKGROUND OF THE INVENTION

1. Field of the Invention

The present invention relates to a drive device, and more particularly to a drive device for a hydraulic caliper brake assembly in which there is no piston mounted.

2. Description of Related Art

Referring to U.S. Pat. No. 6,491,144, a conventional hydraulic caliper brake assembly in accordance with the prior art comprises a caliper housing, a pair of friction members, a plurality of pistons, and a brake operating mechanism. The caliper housing is fixedly coupled to front rear fork or frame in a conventional manner using threaded fasteners. The friction members are coupled to the caliper housing to form a rotor/disk receiving slot therebetween. At least one of the friction members is movable relative to the caliper housing. At least one piston is movably coupled to the caliper housing. Preferably, each piston is movably coupled to the caliper housing. The space between the caliper housing and the piston is filled with the brake oil, and therefore the oil seals are needed to prevent from a leakage. Moreover, the manufacturing tolerance for the caliper housing and the piston is small for avoiding the leaking problem as assembling together. Therefore the manufacturing cost is high. The parts of conventional hydraulic caliper brake assembly are numerous. The assembling time and the total cost are raised due to the numerous parts.

Furthermore, the present of the piston will increase the size of the hydraulic caliper brake assembly. The enlarged hydraulic caliper brake assembly will increase the possibility of collision, and therefore the hydraulic caliper brake assembly will be damaged and the brake function will be affected.

The present invention has arisen to mitigate and/or obviate the disadvantages of the conventional hydraulic caliper brake assembly.

### SUMMARY OF THE INVENTION

The main objective of the present invention is to provide an improved drive device for a hydraulic caliper brake assembly, in that an economical and compact hydraulic caliper brake assembly is acquired.

To achieve the objective, the drive device for the hydraulic caliper brake assembly comprises a housing having an open chamber and an elastomer sealingly mounted in the chamber for containing brake oil. The elastomer includes a skirt connected to an inner peripheral of the chamber, a projection adapted to a brake shoe, and a U-shaped portion positioned between the skirt and the projection for providing the displacement of the projection. A plate is disposed between the housing and the elastomer. A shoulder mounted on the plate is corresponded to an annular flange mounted on elastomer for retaining the elastomer. When hydraulic pressure is greater than the elastic force of the elastomer, the projection of the elastomer is pushed toward the brake shoe to achieve the braking purpose. On the contrary, the projection of the elastomer is restored to a free condition.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a drive device for a hydraulic caliper brake assembly in accordance with the present invention;

FIG. 2 is an exploded perspective view of the drive device for the hydraulic caliper brake assembly in FIG. 1;

FIG. 3 is a cross-sectional view of the drive device for the hydraulic caliper brake assembly in accordance with the present invention; and

FIG. 4 is a cross-sectional view showing the operation of the drive device for the hydraulic caliper brake assembly of the present invention when the elastomer extends to drive the brake shoe.

### DETAILED DESCRIPTION OF THE INVENTION

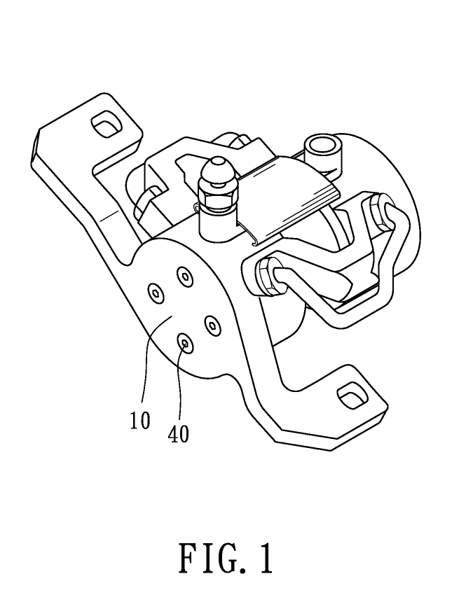

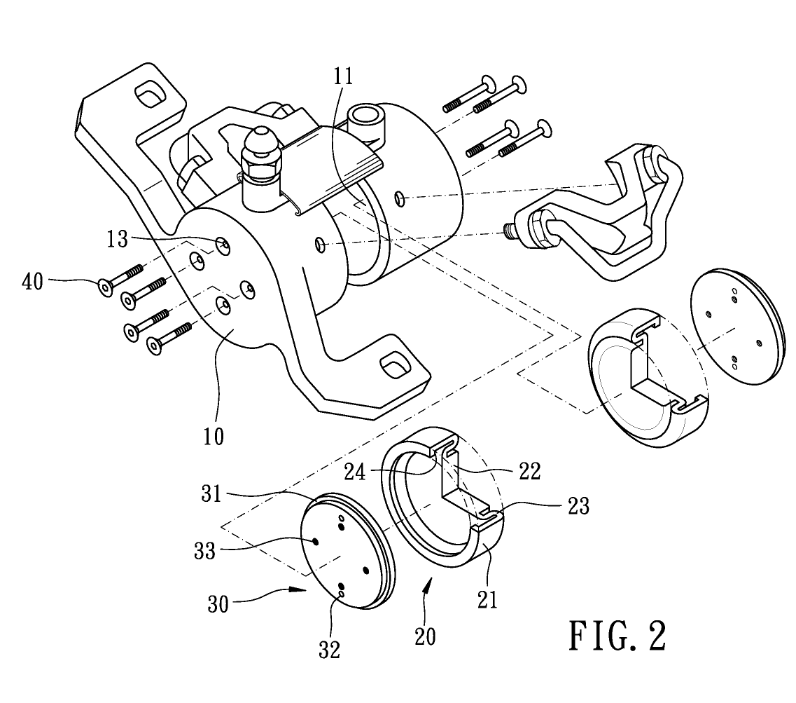

Referring to the drawings and initially to FIGS. 1-3, a drive device for a hydraulic caliper brake assembly in accordance with the present invention comprises a housing 10, at least one elastomer 20 mounted in the housing 10, and at least one plate 30 disposed between the housing 10 and the at least one elastomer 20.

The housing 10 has at least one open circular chamber 11 defined therein for receiving the at least one elastomer 20 and the at least one plate 30. In the preferred embodiment, the housing 10 has two symmetrical chambers 11 for receiving an elastomer 20 and a plate 30 respectively. In the following description, the embodiment is described in a single chamber 11.

The housing 10 has a channel 12 defined in a lateral side of the housing 10 for communicating with an oil tube and the chamber 11. The housing 10 includes a plurality of first holes 13 defined in the lateral side and extending to the chamber 11.

The elastomer 20 is form of rubber and in a circular shape. The elastomer 20 is sealingly mounted concentrically in the chamber 11 for closing the chamber 11 and containing brake oil. The elastomer 20 has a skirt 21 laterally extending from a periphery thereof and connected to an inner peripheral of the chamber 11, a projection 22 centrally formed on the elastomer 20 and adapted to push a brake shoe, and a U-shaped portion 23 formed between the skirt 21 and the projection 22. A thickness of the projection 22 is greater than a thickness of others of the elastomer 20 for preventing the projection 22 from being deformed. In a free condition the U-shaped portion 23 is retained the same shape by the elastic force thereof. As applying force, the U-shaped portion 23 is deformed for providing a displacement of the projection 22. The elastomer 20 includes an annular flange 24 adjacent to the skirt 21. The annular flange 24 extends inwardly and perpendicularly from a distal end of the skirt 21.

The plate 30 is circle-shaped. The plate 30 has a shoulder 31 formed on a periphery thereof and corresponded to the annular flange 24 of the elastomer 20 for retaining the elastomer 20. The plate 30 has a plurality of apertures 32 communicating with the channel 12 in the housing 10 for passing the brake oil. The plate 30 includes a plurality of second holes 33 each aligning with a corresponding one of the first holes 13 in the housing 10.

In assembly, a plurality of fasteners 40 each passes through a corresponding one the first holes 13 in the housing 10 and fastens with a corresponding one of the second holes 33 in the plate 30 for fixing the plate 30 with the elastomer 20. The shoulder 31 corresponded to the annular flange 24 fixes the elastomer 20 in the chamber 11.

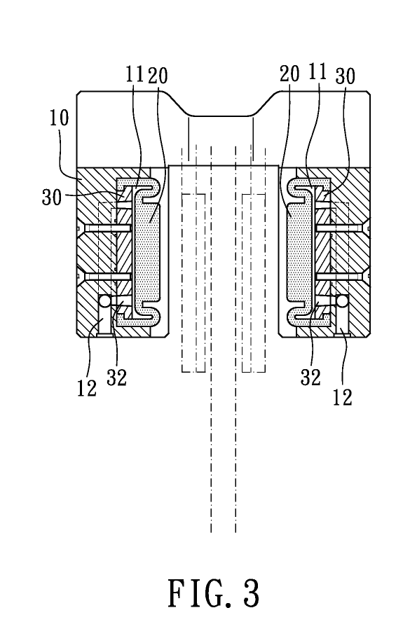

Referring to FIG. 3, the free condition of the drive device for the hydraulic caliper brake assembly is illustrated. A space between the elastomer 20 and the plate 30 is fully filled with brake oil.

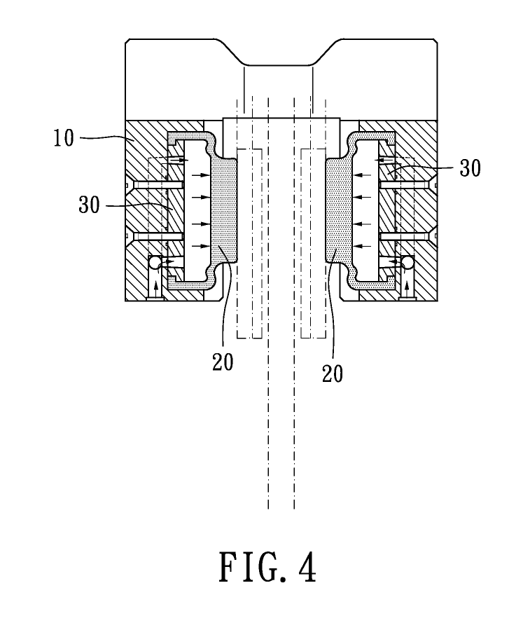

Referring to FIG. 4, the operation of the drive device for the hydraulic caliper brake assembly is illustrated. When user operates the brake lever, the oil pressure between the plate 30 and the elastomer 20 is greater than the elastic force of the elastomer 20. In the meantime, the projection 22 of the elastomer 20 is pushed toward the brake shoe to achieve the braking purpose. Due to the flexibility of the U-shaped portion 23, the U-shaped portion 23 is deformed and provides the displacement of the projection 22. The rigidity of the projection 22 provides a uniform force to the brake shoe. When user releases the brake lever, the oil pressure between the plate 30 and the elastomer 20 is less than the elastic force of the elastomer 20. The U-shape potion 23 and the projection 22 restore to the original condition. Therefore there is no braking force provided.

Although the invention has been explained in relation to its preferred embodiment, it is to be understood that many other possible modifications and variations can be made without departing from the spirit and scope of the invention as hereinafter claimed.

What is claimed is:

1. A drive device for a hydraulic caliper brake assembly, comprising:
a housing having at least one open chamber defined therein; and
at least one elastomer sealingly mounted in the at least one chamber for containing brake oil, the at least one elastomer having a projection adapted to a brake shoe.

2. The drive device for the hydraulic caliper brake assembly as claimed in claim 1, wherein the at least one elastomer has a U-shaped portion formed adjacent to the projection.

3. The drive device for the hydraulic caliper brake assembly as claimed in claim 1 further comprising at least one plate disposed between the housing and the at least one elastomer, a shoulder mounted on the at least one plate and corresponded to an annular flange mounted on the at least one elastomer for retaining the at least one elastomer.

4. The drive device for the hydraulic caliper brake assembly as claimed in claim 2 further comprising at least one plate disposed between the housing and the at least one elastomer, a shoulder mounted on the at least one plate and corresponded to an annular flange mounted on the at least one elastomer for retaining the at least one elastomer.

5. The drive device for the hydraulic caliper brake assembly as claimed in claim 3, wherein the at least one plate has a plurality of apertures for communicating brake oil.

6. The drive device for the hydraulic caliper brake assembly as claimed in claim 4, wherein the at least one plate has a plurality of apertures for communicating brake oil.

7. The drive device for the hydraulic caliper brake assembly as claimed in claim 1, wherein the housing has a channel for feeding brake oil.

8. The drive device for the hydraulic caliper brake assembly as claimed in claim 1, wherein the at least one elastomer is form of rubber.
